(19) United States
(12) Patent Application Publication
(10) Pub. No.: US 2001/0012172 A1
(43) Pub. Date: Aug. 9, 2001

(54) DUAL STAGE DISC DRIVE ACTUATION SYSTEM

(76) Inventors: MUHAMMAD A. HAWWA, SIMI VALLEY, CA (US); JOSEPH M. SAMPIETRO, TARZANA, CA (US); TIEN Q. LE, CAMARILLO, CA (US); LEROY A. VOLZ, NORTHRIDGE, CA (US); DANIEL R. VIGIL, AGOURA HILLS, CA (US)

Correspondence Address: JONATHAN E OLSON, SEGATE TECHNOLOGY LLC, INTELLECTUAL PROPERTY DEP-COL21GL, 389 DISC DRIVE, LONGMONT, CO, 80503, US

(21) Appl. No.: 09/034,540

(22) Filed: Mar. 3, 1998

Related U.S. Application Data
(63) Continuation-in-part of application No. 08/836,292, filed on May 12, 1997, now Pat. No. 6,052,251.
(60) Provisional application No. 60/030,406, filed on Nov. 1, 1996.

(51) Int. Cl. G11B 5/596

(52) U.S. Cl. 360/78.05

(57) ABSTRACT

A dual-stage disc drive actuation system for positioning a transducing head over a selected track of a rotatable disc having a plurality of concentric tracks includes a low resolution actuator and a high resolution microactuator. An input circuit provides a signal corresponding to the selected track. The actuator and microactuator are then operated to position the head over the selected track. The dual-stage actuation system positions the head over the selected track without significant off-track error within about 0.5 milliseconds for a track density of at least about 12,000 tracks-per-inch.

### CROSS-REFERENCE TO RELATED APPLICATIONS

This application is a continuation-in-part of copending U.S. application Ser. No. 08/836,292 filed May 12, 1997 for “Actuator Arm Integrated Piezoelectric Microactuator” by K. Mohajerani, J. Sampietro, A. Fard, J. Barina, M. Hawwa, L. Volz, T. Le and D. Vigil, which in turn claims priority from U.S. provisional application Ser. No. 60/030,406 filed Nov. 1, 1996 for “Eblock Integrated Piezo Electric Actuator” by K. Mohajerani, J. Sampietro, A. Fard, J. Barina and M. Hawwa.

Reference is hereby made to copending U.S. application Ser. No. 08/836,265 filed May 1, 1997 for “Bimorph Piezoelectric Microactuator Head and Flexure Assembly” by M. Hawwa, J. Sampietro, A. Fard, J. Barina and K. Mohajerani.

### BACKGROUND OF THE INVENTION

The present invention relates to a mechanism for positioning a transducing head in a disc drive system, and more particularly relates to a dual stage servo system for controlling a coarse actuator and a fine microactuator to achieve high resolution head positioning in a disc drive system.

Concentric data tracks of information are being recorded on discs with increasing track densities, which reduces the margin for error in positioning a transducing head over a selected track due to the reduced radial distance between tracks and the narrow radial width of the tracks themselves. Typical actuator motors lack sufficient resolution to accurately position a head in a system implementing a disc with a high track recording density.

Various proposals have been made to provide a second, high resolution motor, or microactuator, to finely position a head at a radial position over a track, in addition to the low resolution actuator motor. These “dual-stage actuation” systems have taken a variety of forms. Some of the proposed designs would install a microactuator in the head slider itself, other proposed designs would replace a conventional gimbal with a specially designed silicon gimbal having a microactuator formed directly on the gimbal itself, and still other proposed designs would mount a microactuator motor where the actuator arm meets the head suspension. One example of a potential microactuator design is disclosed in the above-mentioned copending U.S. application Ser. No. 08/836,265 for “Bimorph Piezoelectric Microactuator Head and Flexure Assembly.”

Microactuator designs that require minimal additional design steps compared to conventional actuator assemblies are generally preferred. A dual-stage servo control system with high bandwidth for controlling both a large-scale actuator and a small-scale microactuator is required to effectively implement a dual-stage actuation system.

### SUMMARY OF THE INVENTION

The present invention is a dual-stage disc drive actuation system for positioning a transducing head over a selected track of a rotatable disc having a plurality of concentric tracks. The system includes a low resolution actuator and a high resolution microactuator. An input circuit provides an input signal corresponding to the selected track. The actuator and microactuator are then operated to position the head over the selected track. First control signals are provided to the actuator to coarsely position the head over or near the selected track and second control signals are provided to the microactuator to position the head over the selected track, in response to position signals from the head representative of a current position of the head and the input signal representative of a desired position of the head. The dual-stage actuation system of the present invention positions the head over the selected track without significant off-track error within about 0.5 milliseconds for a track density of at least about 12,000 tracks-per-inch.

### BRIEF DESCRIPTION OF THE DRAWINGS

FIG. 1 is a top view of a dual-stage actuation system utilizing a piezoelectric element embedded in the actuator arm.

FIG. 2 is a side view of the dual-stage actuation system of FIG. 1.

FIG. 3 is a top view of a dual-stage actuation system utilizing two piezoelectric elements embedded in opposite sides of the actuator arm.

FIG. 4 is a side view of the dual-stage actuation system of FIG. 3.

FIG. 5 is a flow diagram illustrating a process of embedding a piezoelectric element in the actuator arm.

FIG. 6 is a block diagram illustrating the functional elements of a feedback servo controller circuit usable with a dual-stage actuation system according to a first embodiment of the present invention.

FIG. 7 is a block diagram illustrating the functional elements of an alternate feedback servo controller circuit usable with a dual-stage actuation system according to a second embodiment of the present invention.

FIGS. 8A-8J are graphs comparing the performance of the prior art with that of the present invention.

### DETAILED DESCRIPTION OF THE PREFERRED EMBODIMENTS

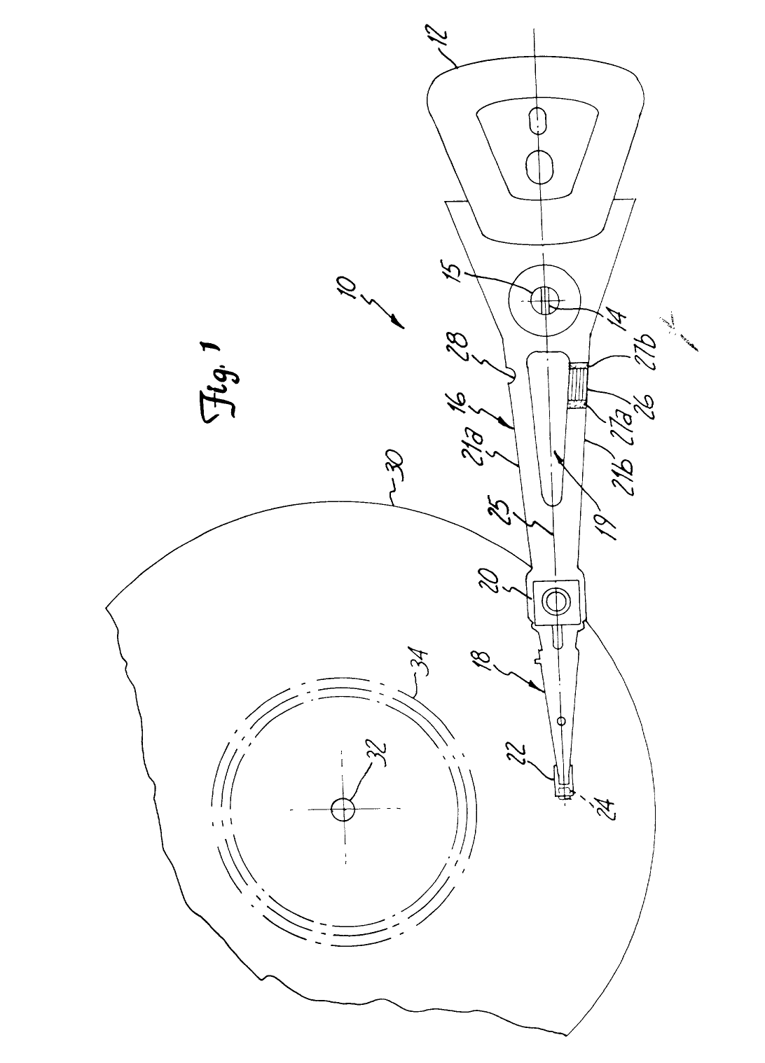

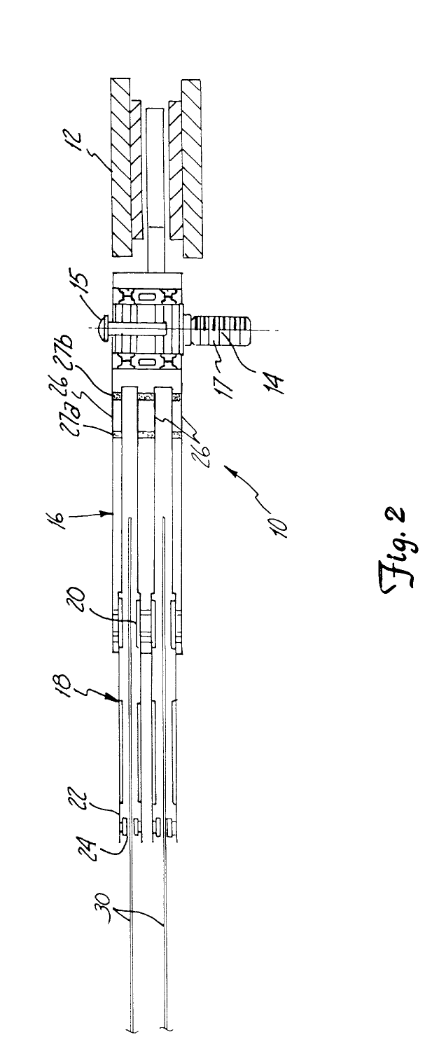

FIG. 1 is a top view, and FIG. 2 is a side view, of a dual-stage actuation system 10. Actuation system 10 includes a voice coil motor 12 operable to rotate actuator arms 16 of an E-block about axis 14 of shaft 17. Screw 15 fastens the top of actuator shaft 17 to a top cover (not shown). Head suspension 18 is connected to a distal end of actuator arm 16 by head suspension mounting block 20. Gimbal 22 is attached to a distal end of head suspension 18. Slider 24 is mounted to gimbal 22 in a manner known in the art. Voice coil motor 12 is a low resolution motor for coarse positioning of actuator arms 16 of the E-block. Voice coil motor 12 is operatively attached to actuator arm 16. Actuator arm 16 is rotatable around axis 14 in response to operation of voice coil motor 12, and has a longitudinal axis 25 normal to axis 14. Actuator arm 16 includes a space 19 forming arm side portions 21a and 21b on each side of longitudinal axis 25. Voice coil motor 12, actuator arm 16, head suspension 18, head suspension mounting block 20, gimbal 22, and slider 24 are all standard disc drive system components, manufactured in a manner known in the art.

Piezoelectric element 26 is embedded in side portion 21b of actuator arm 16, and expands and contracts in response to a voltage applied to its terminals 27a and 27b. The size of piezoelectric element 26 is varied in proportion to the voltage across its terminals 27a and 27b. Relief 28 is provided in side portion 21a of actuator arm 16, to reduce the force required to distort actuator arm 16 by selective expansion and contraction of piezoelectric element 26.

In operation, voice coil motor 12 is operated to rotate actuator arm 16 around axis 14 to effect coarse positioning of slider 24 over a selected region of a rotatable disc 30. Disc 30 rotates around disc axis 32, and includes a plurality of concentric tracks 34 radially positioned around disc axis 32. Once coarse positioning has been achieved, a voltage is applied to piezoelectric element 26 to cause selective expansion or contraction of the piezoelectric element, thereby causing distortion of actuator arm 16 to effect fine positioning of slider 24 over a selected track of rotatable disc 30.

Piezoelectric element 26 is preferably positioned as near to rotational axis 14 of actuator arm 16 as possible, and as near to longitudinal axis 25 of actuator arm 16 as possible, so that the arc of fine positioning of slider 24 by expansion and contraction of piezoelectric element 26 approximates the designed head positioning arc as nearly as possibly, thereby minimizing head skew and maximizing the displacement of slider 24 for a corresponding expansion or contraction of piezoelectric element 26. Although many locations of piezoelectric element 26 along the length of actuator arm 16 are effective, piezoelectric element 26 is located within 20% of the length of actuator arm 16 from axis 14 (“near” axis 14) in a preferred embodiment, to achieve maximum amplification of expansion and contraction of piezoelectric element 26, minimize head skew, and minimally affect the balance and inertia of actuator arm 16. To assure distortion close to axis 14, relief 28 is formed in side portion 21a as near as possible to axis 14 as well.

Because the voltage across the piezoelectric element 26 is directly proportional to the size of the element, a current state of piezoelectric element 26 is readily ascertainable. This enables the actuation system to easily determine the incremental displacement (and voltage) required to adjust the piezoelectric element to position the head over the selected track of the disc. More efficient fine positioning of the head can thereby be achieved.

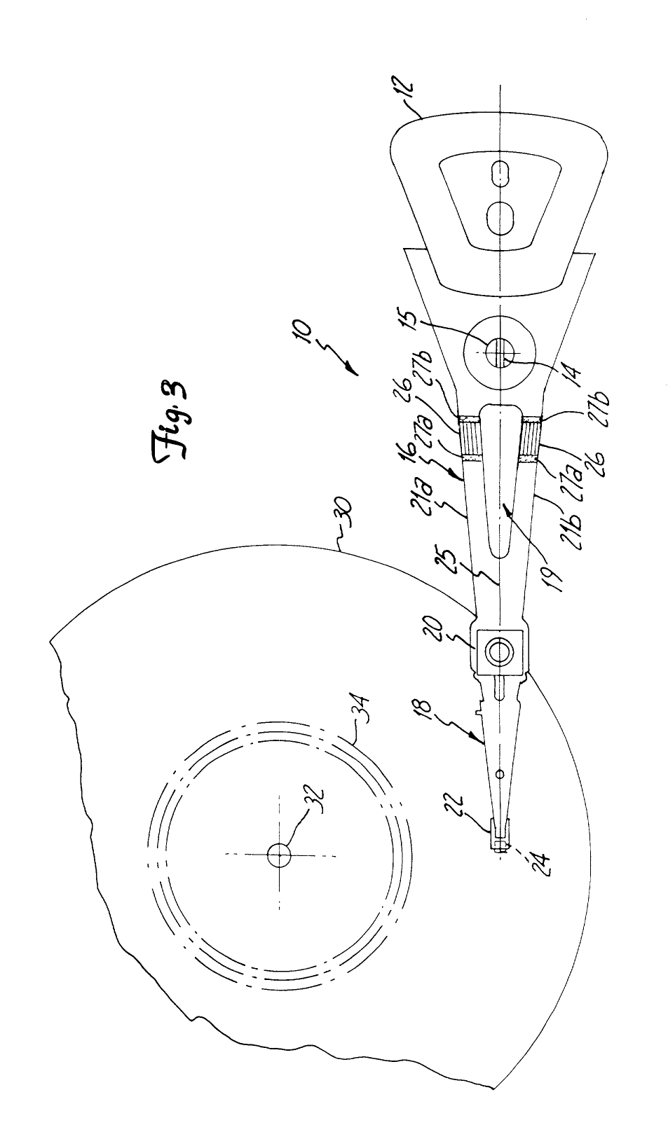

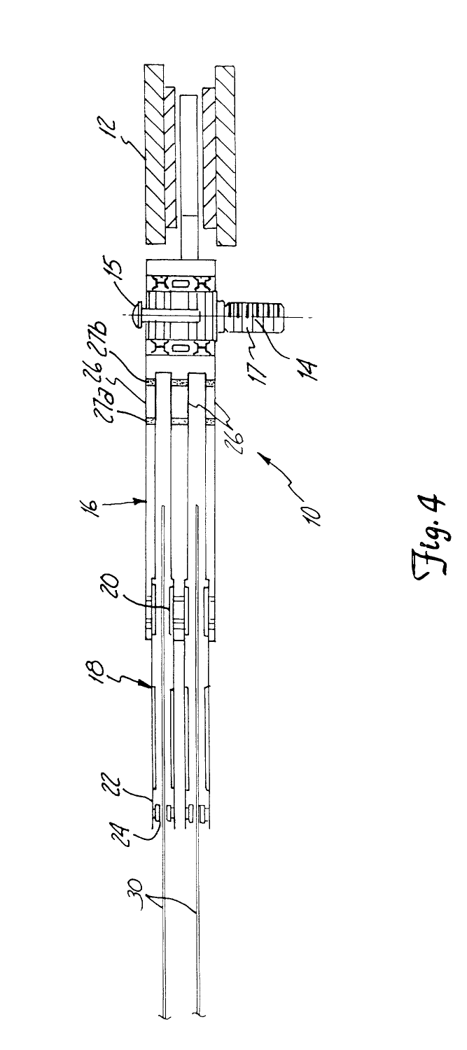

FIG. 3 is a top view, and FIG. 4 is a side view, showing an alternative dual-stage actuation system 10. Actuation system 10 includes a voice coil motor 12 operable to rotate actuator arms 16 of an E-block about axis 14 of shaft 17. Screw 15 fastens the top of actuator shaft 17 to a top cover (not shown). Head suspension 18 is connected to a distal end of actuator arm 16 by head suspension mounting block 20. Gimbal 22 is attached to a distal end of head suspension 18. Slider 24 is mounted to gimbal 22 in a manner known in the art. Voice coil motor 12 is a low resolution motor for coarse positioning of actuator arms 16 of the E-block. Voice coil motor 12 is operatively attached to actuator arm 16. Actuator arm 16 is rotatable around axis 14 in response to operation of voice coil motor 12, and has a longitudinal axis 25 normal to axis 14. Actuator arm 16 includes a space 19 forming arm side portions 21a and 21b on each side of longitudinal axis 25. Voice coil motor 12, actuator arm 16, head suspension 18, head suspension mounting block 20, gimbal 22, and slider 24 are all standard disc drive system components, manufactured in a manner known in the art.

Piezoelectric elements 26 are embedded in side portions 21a and 21b actuator arm 16, and are preferably implemented with opposite polarities, so that a voltage introduced across terminals 27a and 27b of both piezoelectric elements induces expansion of one side portion of actuator arm 16 and contraction of the other side portion of actuator arm 16. This complementary arrangement of piezoelectric elements 26 allows a greater distortion of actuator arm 16 to be achieved, thereby enabling greater displacement of slider 24. Piezoelectric elements 26 are preferably positioned as near to rotational axis 14 of actuator arm 16 as possible, and as near to longitudinal axis 25 of actuator arm 16 as possible, so that the arc of fine positioning of slider 24 by expansion and contraction of piezoelectric elements 26 approximates the designed head positioning arc as nearly as possibly, thereby minimizing head skew and maximizing the displacement of slider 24 for a corresponding expansion or contraction of piezoelectric elements 26. While many locations of piezoelectric elements 26 are effective, piezoelectric elements 26 are located within 20% of the length of the actuator arm from axis 14 (“near” axis 14) in a preferred embodiment, to maximize amplification of expansion and contraction of piezoelectric elements 26, minimize head skew, and minimally affect the balance and inertia of actuator arm 16.

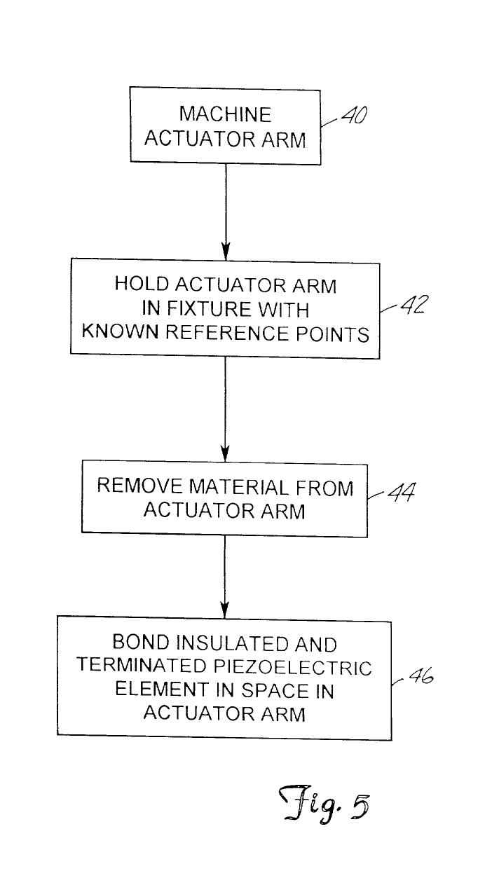

FIG. 5 is a flow diagram illustrating the process steps for embedding a piezoelectric element into the actuator arm. First, at step 40, the actuator arm is formed such that space 19 creates arm side portions 21a and 21b, space 19 extending as close as possible to axis 14. At step 42, the actuator arm is placed in a fixture and aligned to known reference points. A predetermined section of material is then removed at step 44, from one or both of side portions 21a and 21b of the actuator arm at the end of space 19 closest to axis 14. Finally, at step 46, an insulated and terminated piezoelectric element is bonded in the section in the arm portion where material was removed. If only one side portion 21a or 21b is fitted with a piezoelectric element, it is preferred that step 44 additionally includes machining relief 28 (FIG. 1) into the other side portions.

By embedding the piezoelectric element in a conventional actuator arm, a microactuator is provided without requiring additional design of the actuator arm, head suspension, head suspension mounting block, gimbal, or slider. These components are manufactured according to existing processes known in the art.

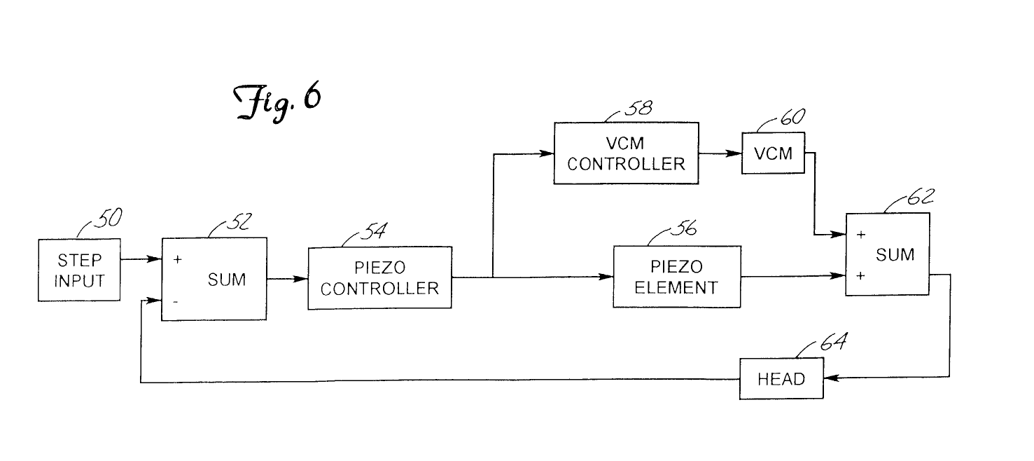

FIG. 6 is a logical block diagram of the functional elements of a dual-stage actuation control system according to a first embodiment of the present invention. The actuation control system includes a step input circuit 50, summing circuit 52, piezoelectric element controller 54, piezoelectric element 56, VCM controller 58, VCM 60, summing block 62, and head 64.

Step input 50 provides an electrical signal corresponding to a position of the destination track to which the head is to be moved. Summing circuit 52 subtracts the position of the track over which the head is currently positioned, as interpreted from the servo information read by head 64 from the disc, from the destination track position provided by step input 50. Thus, summing circuit 52 provides a signal indicative of the distance that the head must traverse, and the direction in which the head must move. Piezoelectric element controller 54 analyzes the distance which the head must traverse, and distributes the required movement among piezoelectric element 56 and VCM 60. Piezoelectric element controller 54 provides the necessary signals to control the movement of piezoelectric element 56 (that is, provides a voltage across the terminals of piezoelectric element 56), and VCM controller 58 provides the signals necessary to control the movement of VCM 60. Summing block 62 represents the total movement effected by VCM 60 and piezoelectric element 56, so that the output of summing block 62 represents the total physical movement of the head. Head 64 reads servo information from the disc, which is interpreted to determine the track over which the head is currently positioned. The current track position is subtracted by summing circuit 52 from the destination track position provided by step input circuit 50, and the functional loop is iterated again.

The dual-stage actuation control system of the present invention may be operated with a disc having a track recording density that is so high that VCM 60 only has sufficient resolution to move the head in increments of five tracks, for example. In one example, step input 50 may provide a signal indicating that the head is to move from track number 100 to track number 208. Summing circuit 52 subtracts the position of the current track (100) from the position of the desired track (208) to determine that the head must move a distance corresponding to 108 tracks in the positive displacement direction. This information is provided to piezoelectric element controller 54. Piezoelectric element controller 54 may, for example, be configured with the capability of operating piezoelectric element 56 to move the head up to five tracks. Thus, when piezoelectric element controller 54 analyzes the desired movement of 108 tracks, it sends a signal to piezoelectric element 56 that causes piezoelectric element 56 to move the head its maximum radial displacement, five tracks. This movement is not enough to obtain the desired head movement (108 tracks), so piezoelectric element controller 54 distributes the remainder of the head movement to VCM 60. In this example, VCM controller 58 receives a signal from piezoelectric element controller 54 that indicates there is a distance corresponding to 103 tracks left to traverse. VCM controller 58 then operates VCM 60 to move the head 100 tracks. The total movement by VCM 60 and piezoelectric element 56, symbolized as being summed in block 62, is 105 tracks. Thus, the track over which head 64 is currently positioned is track number 205.

This position of the current track (205) is subtracted from the position of the destination track (208) by summing circuit 52, yielding a desired track movement of three tracks in the positive displacement direction. However, piezoelectric element controller 54 has already operated piezoelectric element 56 to its maximum extent. Therefore, piezoelectric element controller 54 distributes the desired three-track movement by sending a signal to VCM controller 58 to operate VCM 60 to move the head one more increment (5 tracks), and operates piezoelectric element 56 to displace the head two tracks less than its maximum (3 tracks). Thus, the movement of head 64 effected by VCM 60 is 105 tracks, and the movement of head 64 effected by piezoelectric element 56 is three tracks. These movements are symbolically added in block 62, to yield a total movement of 108 tracks, and the head is positioned over track number 208, as determined from the servo information read by head 64. The position of the current track (208) is subtracted from the position of the destination track (208) at summing circuit 52, yielding a desired track movement of zero tracks. The logical loop continues in this steady state until a new desired track position is input by step input circuit 50.

The actuation system is preferably also designed to compensate for small off-track errors, such as one-quarter or other fractional track errors, for example. Thus, when head 64 detects an off-center condition, a correction signal is passed through summing circuit 52 to controller 54 to operate piezoelectric element 56. Piezoelectric element 56 has sufficient resolution to correct these off-track errors, to center the head over the desired track. When these small adjustments need to be made, piezoelectric controller 54 serves to distribute the head centering movement to piezoelectric element 56, so that VCM 60 is not operated for such minuscule movements.

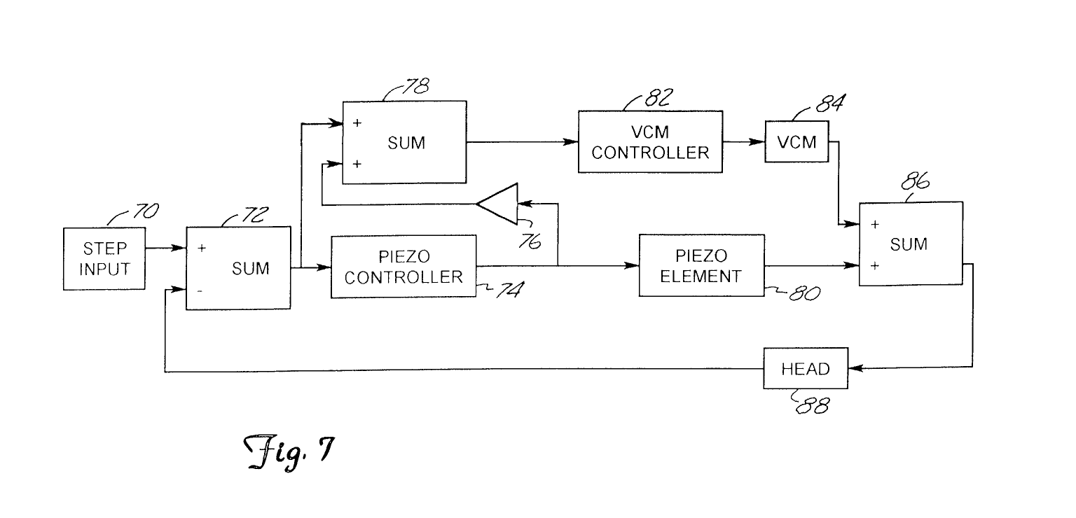

FIG. 7 is a logical block diagram of the functional elements of an alternative dual-stage actuation control system according to a second embodiment of the present invention, including a step input circuit 70, summing circuit 72, piezoelectric element controller 74, inverter 76, summing circuit 78, piezoelectric element 80, VCM controller 82, VCM 84, summing block 86, and head 88.

Step input 70 provides an electrical signal representative of the position of the destination track to which the head is to be moved. Summing circuit 72 subtracts the position of the track over which the head is currently positioned, as interpreted from the servo information read by head 88 from the disc, from the destination track position provided by step input 70. Thus, summing circuit 72 provides a signal indicative of the distance that the head must traverse, and the direction in which the head must move. Piezoelectric element controller 74 analyzes the distance that the head must traverse, and provides a signal to control the movement of piezoelectric element 80 (that is, provides a voltage across the terminals of piezoelectric element 80) based on the required track movement received from summing circuit 72. The signal provided from piezoelectric element controller 74 is inverted by inverter 76, and summing circuit 78 adds the required track movement from summing circuit 72 and the inverted movement achieved by piezoelectric element 80 under the control of piezoelectric element controller 74, yielding a signal representing the required track movement remaining. VCM controller 82 analyzes the distance left for the head to traverse, and provides signals to control the movement of VCM 84 to achieve that motion. Summing block 86 represents the total movement effected by VCM 84 and piezoelectric element 80, so that the output of summing block 86 represents the total physical movement of the head. Head 88 reads servo information from the disc, which is interpreted to determine the track over which the head is currently positioned. The current track position is subtracted by summing circuit 72 from the destination track position provided by step input circuit 70, and the functional loop is iterated again.

The dual-stage actuation control system shown in FIG. 7 operates in a manner that is logically similar to the actuation control system shown in FIG. 6 and described previously, assuming similar voice coil motor and microactuator designs. The control system shown in FIG. 7 contains slightly more components than the system shown in FIG. 6, but also requires a less complex piezoelectric element controller. It will be apparent to one skilled in the art that the control systems shown in FIGS. 6 and 7 effectively operate a low resolution motor to effect coarse positioning of a head, and also operate a high-resolution piezoelectric microactuator to effect fine positioning of the head, while preventing application of a voltage to the high resolution piezoelectric microactuator that exceeds the range of allowable voltages, which would saturate the microactuator and inhibit the performance of the system.

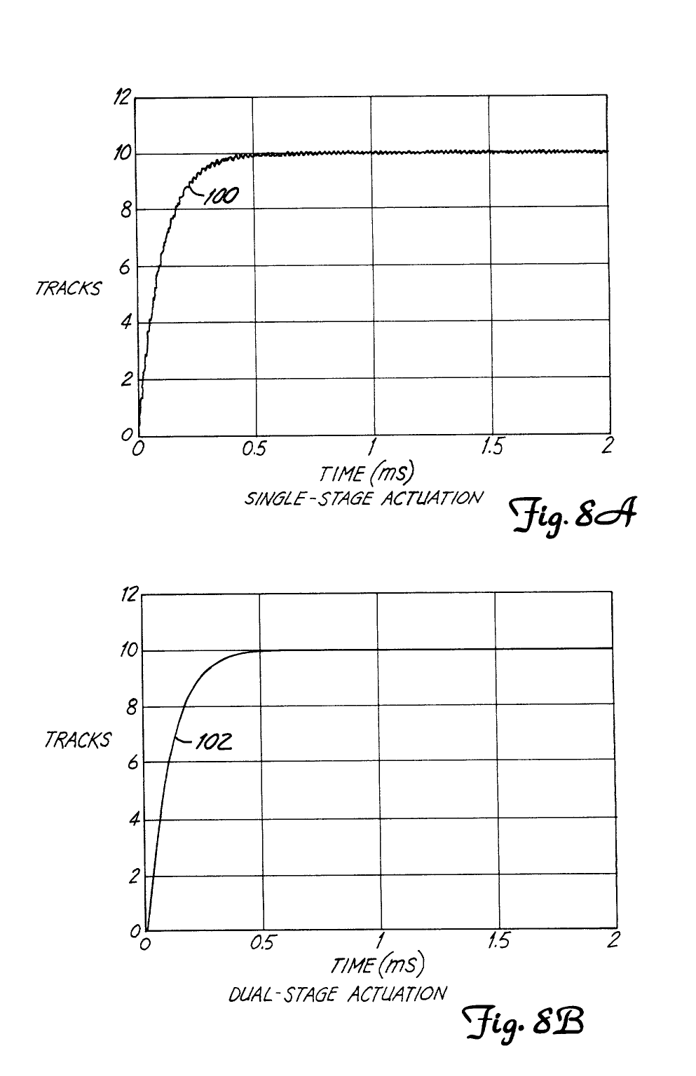

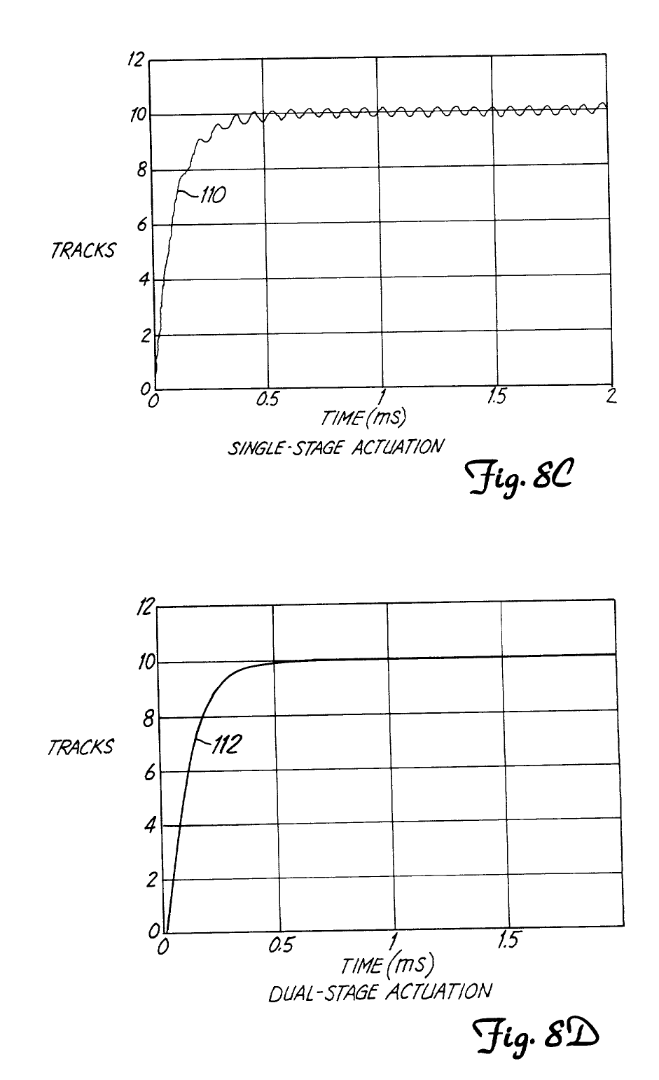

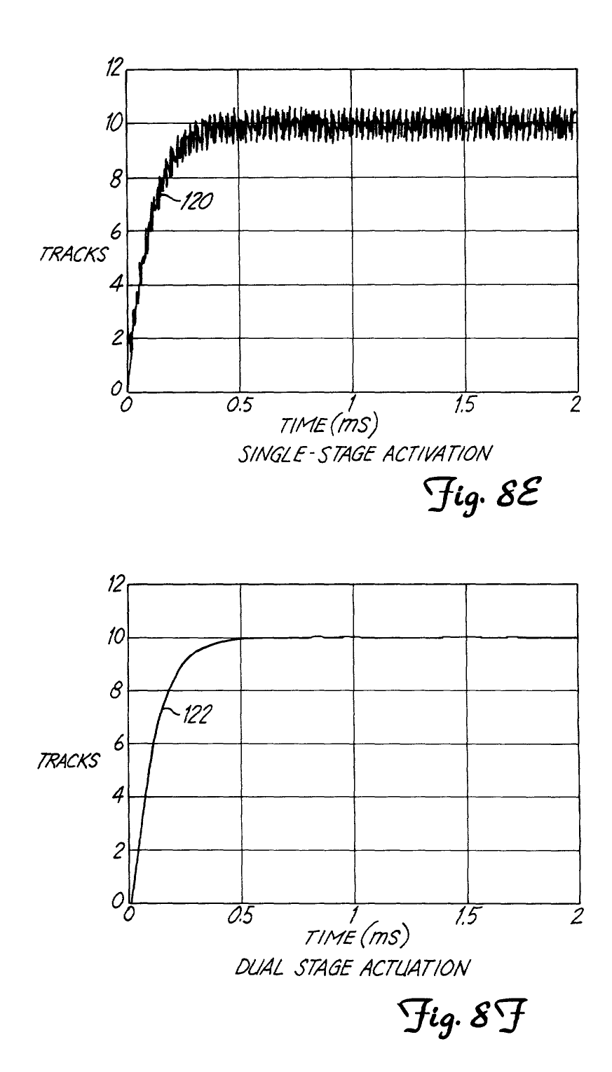

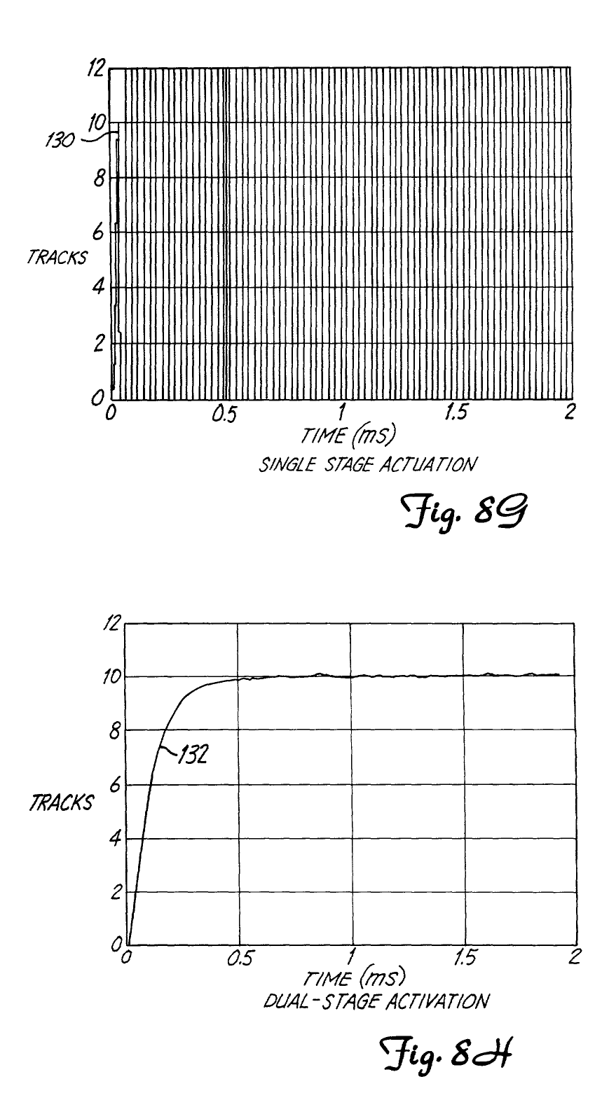

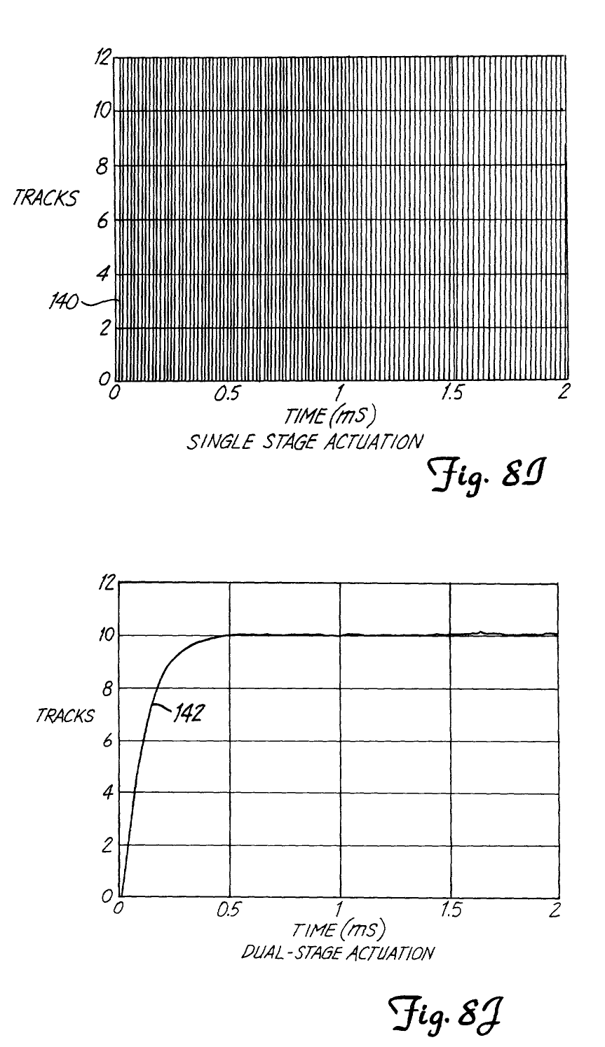

FIGS. 8A-8J are graphs illustrating the typical performance of a single-stage actuation system compared to the typical performance of the dual-stage actuation system of the present invention. The performance characteristics discussed below with respect to FIGS. 8A-8J are exemplary for a particular disc drive system such as a Medalist ST52520 drive manufactured by Seagate Technology, Inc. It will be understood by one skilled in the art that other disc drive systems may exhibit slightly different performance characteristics, depending on the mechanical configuration of the actuator and other components utilized therein, but the effect illustrated in FIGS. 8A-8J of improving head positioning performance for increased track densities is achieved by the present invention for a variety of disc drive systems having various actuator and component configurations. FIGS. 8A and 8B show head position for a traversal from track 0 to track 10, where the tracks are spaced with a density of 10,000 tracks per inch (TPI). As shown by curve 100, the single-stage actuation system positions the head over track 10 with relatively little off-track error within 0.5 milliseconds. Curve 102 illustrates that the dual-stage actuation system of the present invention also positions the head over track 10 with little or no off-track error within 0.5 milliseconds. A comparison of curves 100 and 102 reveals similar centering and tracking performance by the single-stage and dual-stage actuation systems.

FIGS. 8C and 8D are graphs showing head position for a traversal from track 0 to track 10, where the tracks are spaced with a density of 11,000 TPI. As shown by curve 110, the single-stage actuation system positions the head over track 10 with a small amount of off-track error within 0.5 milliseconds. Curve 112 illustrates that the dual-stage actuation system of the present invention positions the head over track 10 with little or no off-track error within 0.5 milliseconds. Again, a comparison of curves 110 and 112 reveals similar centering and tracking performance by the single-stage and dual-stage actuation systems, with the dual-stage actuation system performing slightly better.

FIGS. 8E and 8F are graphs showing head position for a traversal from track 0 to track 10, where the tracks are spaced with a density of 12,000 TPI. As shown by curve 120, the single-stage actuation system positions the head over track 10 with significant off-track error approaching one whole track. Curve 122 illustrates that the dual-stage actuation system of the present invention positions the head over track 10 with little or no off-track error within 0.5 milliseconds. A comparison of curves 120 and 122 reveals that the dual-stage actuation system yields significantly better tracking and centering performance than the single-stage actuation system.

FIGS. 8G and 8H are graphs showing head position for a traversal from track 0 to track 10, where the tracks are spaced with a density of 13,000 TPI. As shown by curve 130, the single-stage actuation system is unable to position the head over track 10, exhibiting significant off-track error without being able to settle in the vicinity of track 10. This inability to center the head over the selected track is due to the minimum displacement of the actuator being substantially greater than the distance between neighboring tracks, causing oscillation of the head rather than proper tracking. Curve 132 illustrates that the dual-stage actuation system of the present invention positions the head over track 10 with little or no off-track error within 0.5 milliseconds. A comparison of curves 130 and 132 reveals that the dual-stage actuation system continues to yield good tracking and centering performance while the single-stage actuator fails completely for a track density of 13,000 TPI.

FIGS. 8I and 8J are graphs showing head position for a traversal from track 0 to track 10, where the tracks are spaced with a density of 15,000 TPI. As shown by curve 140, the single-stage actuation system is unable to position the head over track 10, exhibiting significant off-track error without being able to settle in the vicinity of track 10. This inability to center the head over the selected track is due to the minimum displacement of the actuator being substantially greater than the distance between neighboring tracks, causing oscillation of the head rather than proper tracking. Curve 142 illustrates that the dual-stage actuation system of the present invention positions the head over track with very little off-track error within 0.5 milliseconds. A comparison of curves 140 and 142 reveals that the dual-stage actuation system continues to yield good tracking and centering performance while the single-stage actuator fails completely for a track density of 15,000 TPI.

The dual-stage actuation system of the present invention efficiently controls the positioning of a head over a selected track of a rotatable disc. A microactuator is integrated into the system, providing high resolution and high bandwidth small-scale head positioning and thereby accommodating high track densities that enable greater amounts of data to be recorded on the disc. The dual-stage servo control system of the present invention may be used with any suitable actuator/microactuator design, distributing movement of the head between the actuator and microactuator as appropriate.

Although the present invention has been described with reference to preferred embodiments, workers skilled in the art will recognize that changes may be made in form and detail without departing from the spirit and scope of the invention.

What is claimed is:

1. A dual-stage actuation system for positioning a transducing head of a disc drive over a selected track of a rotatable disc having a plurality of concentric tracks, the system including a low resolution actuator and a high resolution microactuator and comprising:
an input circuit providing a signal corresponding to the selected track; and
means for operating the low resolution actuator and the high resolution microactuator to position the head over the selected track.

2. A dual-stage actuation system for positioning a transducing head of a disc drive over a selected track of a rotatable disc having a plurality of concentric tracks, the system including a low resolution actuator and a high resolution microactuator and comprising:
an input circuit providing a first signal corresponding to the selected track; and
a feedback loop comprising:
means associated with the head for providing a second signal corresponding to a track currently confronting the head;
a summing circuit comparing the first and second signals to identify a required movement of the head from the current track to the selected track;
a microactuator controller for operating the microactuator to effect fine movement of the head and for providing a control signal representative of a number of tracks remaining to be traversed; and
an actuator controller receiving the control signal from the microactuator controller and operating the actuator in response to the control signal to effect coarse movement of the head.

3. The system of claim 2, wherein the microactuator controller operates the microactuator to effect fine positioning of the head up to a predetermined maximum displacement by the microactuator and provides the control signal to the actuator controller representative of the number of tracks remaining to be traversed beyond the fine positioning by the microactuator.

4. The system of claim 3, wherein if the head is not positioned over the selected track, the microactuator controller operates the microactuator to effect fine positioning of the head to an extent less than the maximum displacement by the microactuator and provides the control signal to the actuator controller representative of an incremental number of tracks remaining to be traversed.

5. A dual-stage actuation system for positioning a transducing head of a disc drive over a selected track of a rotatable disc having a plurality of concentric tracks, the system including a low resolution actuator and a high resolution microactuator and comprising:
an input circuit providing a first signal corresponding to the selected track; and
a feedback loop comprising:
means associated with the head for providing a second signal corresponding to a track currently confronting the head;
a first summing circuit comparing the first signal and the second signal to generate a third signal representing a required movement of the head from the current track to the selected track;
a microactuator controller for providing a fourth signal to operate the microactuator to effect fine movement of the head;
a second summing circuit comparing the third and fourth signals to identify a remaining required movement of the head; and
an actuator controller for operating the actuator based on the remaining required movement of the head to effect coarse movement of the head.

6. A dual-stage actuation system for positioning a transducing head over a selected track of a rotatable disc in a disc drive device, the rotatable disc having a plurality of concentric tracks radially positioned about a disc axis, the system comprising:
a low resolution actuator and a high resolution microactuator for radially positioning the head relative to the disc axis and the selected track of the rotatable disc; and
control circuitry providing first electrical signals to the actuator to coarsely position the head over or near the selected track and providing second electrical signals to the microactuator to position the head over the selected track, the control circuitry being responsive to position signals from the head representative of a current position of the head and an input signal representative of a desired position of the head to selectively provide the first and second electrical signals.

7. The system of claim 6, wherein the control circuitry comprises:
an input circuit providing a first signal corresponding to the selected track; and
a feedback loop comprising:
means associated with the head for providing a second signal corresponding to a track currently confronting the head;
a summing circuit comparing the first and second signals to identify a required movement of the head from the current track to the selected track;
a microactuator controller for operating the microactuator to effect fine movement of the head and for providing a control signal representative of a number of tracks remaining to be traversed; and
an actuator controller receiving the control signal from the microactuator controller and operating the actuator in response to the control signal to effect coarse movement of the head.

8. The system of claim 7, wherein the microactuator controller operates the microactuator to effect fine positioning of the head up to a predetermined maximum displacement by the microactuator and provides the control signal to the actuator controller representative of the number of tracks remaining to be traversed beyond the fine positioning by the microactuator.

9. The system of claim 8, wherein if the head is not positioned over the selected track, the microactuator controller operates the microactuator to effect fine positioning of the head to an extent less than the maximum displacement by the microactuator and provides the control signal to the actuator controller representative of an incremental number of tracks remaining to be traversed.

10. The system of claim 6, wherein the control circuitry comprises:
an input circuit providing a first signal corresponding to the selected track; and
a feedback loop comprising:
means associated with the head for providing a second signal corresponding to a track currently confronting the head;
a first summing circuit comparing the first signal and the second signal to generate a third signal representing a required movement of the head from the current track to the selected track;
a microactuator controller for providing a fourth signal to operate the microactuator to effect fine movement of the head;
a second summing circuit comparing the third and fourth signals to identify a remaining required movement of the head; and
an actuator controller for operating the actuator based on the remaining required movement of the head to effect coarse movement of the head.

11. A dual-stage actuation system for positioning a transducing head of a disc drive over a selected track of a rotatable disc having a plurality of concentric tracks, comprising:
a large scale actuator for effecting coarse movement of the head relative to the selected track;
a small scale microactuator for effecting fine movement of the head relative to the selected track; and
control circuitry for operating the actuator and the microactuator to position the head over the selected track without significant off-track error within about 0.5 milliseconds for a track density of at least about 12,000 tracks-per-inch.
